(19) United States
(12) Patent Application Publication
(10) Pub. No.: US 2025/0131811 A1
(43) Pub. Date: Apr. 24, 2025

(54) Pressure-Sensitive Floor Mat Alarm Clock System

(71) Applicant: Windustries Limited, TSUEN WAN (HK)

(72) Inventor: Yu Hong Tam, TSUEN WAN (HK)

(21) Appl. No.: 18/830,953

(22) Filed: Sep. 11, 2024

Related U.S. Application Data
(60) Provisional application No. 63/591,124, filed on Oct. 18, 2023.

(51) Int. Cl. G08B 21/18

(52) U.S. Cl. CPC G08B 21/182

(57) ABSTRACT

A pressure-sensitive floor mat alarm clock system comprises a sheet form pressure-sensing mechanism for detecting pressure applied thereto by a human foot placed thereon. The system includes a control unit cooperative with the pressure-sensing mechanism to receive an input signal from the pressure-sensing mechanism when pressure is applied to the pressure-sensing mechanism by a human foot, the control unit configured to terminate output of an audible and/or a visual alarm signal in response to receipt of an input signal. The control unit is configured to terminate output of the alarm signal upon a determination that the input signal from the pressure-sensing mechanism is indicative of a user applying foot pressure to the pressure-sensing mechanism for a predetermined duration of time and/or by a predetermined pattern of applied foot pressure.

### FIELD OF THE INVENTION

The invention relates to a pressure-sensitive floor mat alarm clock system.

### BACKGROUND OF THE INVENTION

Conventional alarm clocks are typically placed by users on bedside tables within arm's reach. Even where users utilize their smart phones as their wake-up alarm device in replacement of an alarm clock, the smart phone is typically also placed on a bedside table within arm's reach. Furthermore, where a smart phone is used as a wake-up alarm device, there is a tendency when stopping the alarm signal to then access other functions of the smart phone to check one or more of social media, news feed, emails, messages, and a tendency to scroll for entertainment, etc., all or any of which may delay the user from actually getting out of bed. Also, this encourages too much screen time which is also not conducive to rousing oneself to get out of bed.

One problem many users encounter is the ease and the inclination to trigger a snooze function or even to switch-off the alarm when still in a sleepy slumber with the consequence of delaying waking-up and even sleeping-in much longer than intended.

There is a need to provide an alarm clock system to encourage, cause, or even force a user to wake-up when disarming their alarm clock, i.e., when shutting the alarm signal off.

To mitigate the aforementioned problems, there is a need, among other things, to provide an improved alarm clock.

### OBJECTS OF THE INVENTION

An object of the invention is to mitigate or obviate to some degree one or more problems associated with known alarm clocks.

The above object is met by the combination of features of the main claims; the sub-claims disclose further advantageous embodiments of the invention.

Another object of the invention is to provide a novel alarm clock.

Another object of the invention is to provide a wake-up alarm system that encourages, causes, or even forces a user to wake-up when disarming their alarm clock.

One skilled in the art will derive from the following description other objects of the invention. Therefore, the foregoing statements of object are not exhaustive and serve merely to illustrate some of the many objects of the present invention.

### SUMMARY OF THE INVENTION

In a first main aspect, the invention provides a pressure-sensitive floor mat alarm clock system comprising: a sheet form pressure-sensing mechanism for detecting pressure applied thereto by a human foot placed thereon; and a control unit cooperative with the pressure-sensing mechanism to receive an input signal from the pressure-sensing mechanism when pressure is applied to the pressure-sensing mechanism by a human foot, the control unit configured to terminate output of an audible and/or a visual alarm signal in response to receipt of an input signal from the pressure-sensing mechanism; wherein the control unit is configured to terminate output of the audible and/or the visual alarm signal upon a determination that the input signal from the pressure-sensing mechanism is indicative of a user applying foot pressure to the pressure-sensing mechanism for a predetermined duration of time and/or by a predetermined pattern of applied foot pressure.

In a second main aspect, the invention provides a pressure-sensitive floor mat alarm clock system for facilitating a getting out of bed or wake up routine, the system comprising: a pressure-sensing mechanism capable of detecting touch input; a control unit configured to receive a touch input signal from the pressure-sensing mechanism and to shut-off an alarm signal; a display interface for displaying a clock time; and an input interface for allowing a user to adjust any of: a wake-up time; a time required for the pressure-sensing mechanism to detect touch before the alarm signal is shut-off; selection of one or more alarm signals; a volume setting for an audible alarm signal; and overall navigation of the system's functions.

In a third main aspect, the invention provides a kit of parts comprising the pressure-sensing floor mat alarm clock system of the first main aspect of the invention or the second main aspect of the invention and a cover for covering over or enveloping at least the pressure-sensing mechanism.

The invention may provide a non-transitory computer-readable medium storing machine-readable instructions, wherein, when the machine-readable instructions are executed by a processor or control unit, they configure the processor or control unit implement the method of any aspect of the invention.

The summary of the invention does not necessarily disclose all the features essential for defining the invention; the invention may reside in a sub-combination of the disclosed features.

The forgoing has outlined fairly broadly the features of the present invention in order that the detailed description of the invention which follows may be better understood. Additional features and advantages of the invention will be described hereinafter which form the subject of the claims of the invention. It will be appreciated by those skilled in the art that the conception and specific embodiment disclosed may be readily utilized as a basis for modifying or designing other structures for carrying out the same purposes of the invention.

### BRIEF DESCRIPTION OF THE DRAWINGS

The foregoing and further features of the present invention will be apparent from the following description of preferred embodiments which are provided by way of example only in connection with the accompanying figures, of which:

FIG. 1 is a top perspective view of an embodiment of a pressure-sensitive floor mat alarm clock system in accordance with the invention;

FIG. 2 is an enlarged perspective view of a section of the system of FIG. 1 showing a front view of a control unit;

FIG. 3 is an enlarged plan view of a section of the system of FIG. 1 showing a rear view of the control unit;

FIG. 4 is an enlarged perspective view of the control unit showing various control buttons and other features thereof;

FIG. 5 is a plan view of the pressure-sensitive floor mat alarm clock system of FIG. 1 but including a cover for covering over or enveloping at least the pressure-sensing mechanism of the alarm clock system;

FIG. 6 is a side view of the alarm clock system of FIG. 5;

FIG. 7 is an exploded side view of another embodiment of the alarm clock system of FIG. 5; and

FIG. 8 is an enlarged plan view of the section of the system of FIG. 1 showing a physical and electrical connection between the pressure-sensing mechanism and the control unit.

### DESCRIPTION OF PREFERRED EMBODIMENTS

The following description is of preferred embodiments by way of example only and without limitation to the combination of features necessary for carrying the invention into effect.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments, but not other embodiments.

It should be understood that the elements shown in the drawings may be implemented in various forms of hardware, software, or combinations thereof. These elements may be implemented in a combination of hardware and software on one or more appropriately programmed general-purpose devices, which may include a processor, memory, and input/output interfaces.

The present description illustrates the principles of the present invention. It will thus be appreciated that those skilled in the art will be able to devise various arrangements that, although not explicitly described or shown herein, embody the principles of the invention and are included within its spirit and scope.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of systems and devices embodying the principles of the invention.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

In the claims hereof, any element expressed as a means for performing a specified function is intended to encompass any way of performing that function including, for example, a) a combination of circuit elements that performs that function or b) software in any form, including, therefore, firmware, microcode, or the like, combined with appropriate circuitry for executing that software to perform the function. The invention as defined by such claims resides in the fact that the functionalities provided by the various recited means are combined and brought together in the manner which the claims call for. It is thus regarded that any means that can provide those functionalities are equivalent to those shown herein.

A pressure-sensitive floor mat alarm clock system in accordance with the invention which, when used while placed on a floor, facilitates a user getting out of bed after sleeping, encouraging, causing, or even forcing the user to stand for a preset or predetermined amount of time and/or to perform a predetermined pattern of foot pressure applications on the system to cause the alarm signal to shut-off, helping the user to wake up more efficiently and/or more completely.

The user is enabled to pre-set an alarm time. The user may also be enabled to set an amount of time required for foot pressure to be applied to the system to cause the alarm signal to be shut-off. Additionally, or alternatively, the user may further be enabled to predetermine or select a pattern of foot pressure moves on the system to cause the alarm signal to shut-off.

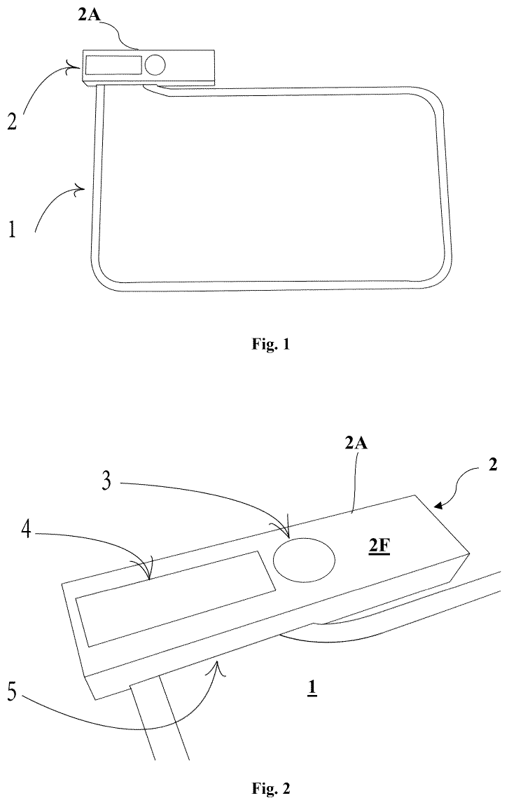

Referring to the drawings, FIG. 1 illustrates, by way of example only and without limitation, an embodiment of a pressure-sensitive floor mat alarm clock system in accordance with the invention. The system comprises a sheet form or planar pressure-sensing mechanism 1 for detecting pressure applied thereto by a human foot placed thereon. . . . The pressure-sensing mechanism 1 may take the form of a floor mat. The pressure-sensing 20 mechanism 1 is designed to be placed on a floor and designed to sense a user's foot pressure when a user steps onto the pressure-sensing mechanism 1. The pressure-sensing mechanism 1 is preferably configured to not only sense the amount of pressure applied by a foot or the feet of a user standing or stepping thereon, but to detect or determine a degree or area of contact of the user's foot or feet on the surface of the pressure-sensing mechanism 1. The pressure-sensing mechanism 1 may comprise any available pressure-sensing mechanism 1 suitable for the purposes of the invention.

The system also comprises a control unit 2 cooperative with the pressure-sensing mechanism 1. The control unit 2 has a housing 2A accommodating a circuit board 2B (FIG. 8) to enable the functions of the system as described herein. The circuit board 2B comprises electronics to implement the functions of the invention. The electronics may comprise a processor 2C and a memory 2D or an application specific circuit board. The memory 2D may store machine-readable instructions which, when executed by the processor 2C, cause the system to implement the various functions of the invention.

The control unit 2 is configured to receive an input signal from the pressure-sensing mechanism 1 when pressure is applied to the pressure-sensing mechanism 1 by the user's foot or feet when standing on or stepping onto the pressure-sensing mechanism 1. Placing the system on the floor near, for example, the user's bed encourages the user to get up from their bed in order to step onto the pressure-sensing mechanism 1 to thereby shut-off an alarm signal initiated at a preset alarm time. Encouraging or causing the user to physically arise and furthermore to make one or more stepping motions improves the alertness of the user and reduces the chances of their returning to bed.

Upon detecting pressure by a user's foot on the pressure-sensing mechanism 1, the control unit 2 is configured to terminate output of an audible and/or a visual alarm signal. Preferably, the control unit 2 is configured to terminate output of the audible and/or the visual alarm signal upon a determination that the input signal from the pressure-sensing mechanism 1 is indicative of a user applying foot pressure to the pressure-sensing mechanism 1 for a preset or predetermined duration of time and/or by a preset, selected, or predetermined pattern of applied foot pressure. One example of a pattern of applied foot pressure would be a user stepping onto and off the pressure-sensing mechanism 1 for say eight times, although any number of times could be preset. One advantage of using a pattern of applied foot pressure is that it causes the user to exert physical effort which awakens at least the user's leg muscles and contributes to fully wakening the user.

In some circumstances, a user may be tempted to reach their hand from a prone position lying in their bed in order to exert hand pressure on the pressure-sensing mechanism 1 in the hope of shutting-off the alarm signal. However, the system is preferably enabled to discriminate between types of pressure applied to the pressure-sensing mechanism 1. The control unit 2 is preferably configured to discriminate between foot pressure applied to the pressure-sensing mechanism 1 by the user and other means of pressure being applied by the user to the pressure-sensing mechanism 1. This may be based on a predetermined or calculated pressure threshold whereby, if a detected touch pressure on the pressure-sensing mechanism 1 is below the predetermined or calculated threshold pressure then the control unit 2 determines that the user has not applied foot pressure to the pressure-sensing mechanism 1 and does not shut-off the alarm signal.

In some embodiments, the predetermined or calculated threshold pressure may be based on one or more user inputted parameters to the control unit 2 such as, for example, the user's weight, the user's shoe size, the user's foot dimensions, etc. The pressure-sensing mechanism 1 may be configured to determine an area of pressure applied by a user. If the area of pressure applied by the user is less than an area of the user's foot or feet, the control unit may ignore the input and not shut-off the alarm signal.

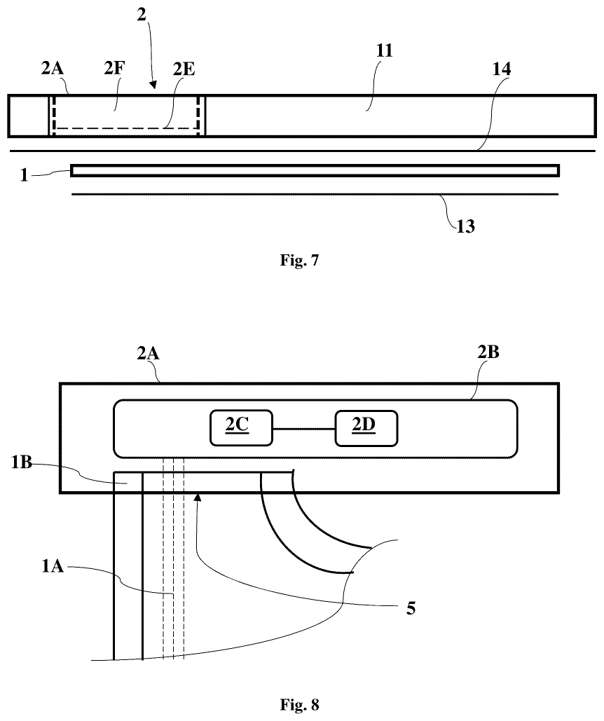

Referring to FIG. 2, shown is an enlarged perspective view of a section of the system of FIG. 1 showing a front view of a control unit 2. The control unit may include an audio speaker system 3 for emitting an audible alarm signal and that is capable of producing sounds with volume up and over 100 decibels. The speaker system 3 may also be used to convey audible messages to a user when inputting settings, parameters, etc. to the control unit 2. The control unit 2 may also include an LED display area 4 where the current time will preferably be displayed, and which will also display other modes of the alarm clock system to assist users in navigating through the functions and settings of the system. The junction where the pressure-sensing mechanism 1 physically and electrically connects to the control unit 2 is denoted by numeral 5 in FIG. 2. This can be better seen in FIG. 8 where the dashed lines are indicative of the electrical circuit connection 1A between the pressure-sensing mechanism 1 and the control unit 2. The electrical circuit connection 1A is enveloped by top and bottom cover layers of material of the pressure-sensing mechanism 1. Preferably, as shown in FIG. 8, a portion 1B of the pressure-sensing mechanism 1 extends into the housing 2A of the control unit 2 such that, when a cover or lid part 2E (FIG. 7) of the housing 2A is attached to a main body part 2F of the housing 2A, the extended portion 1B of the is trapped or clamped between the lid part 2E and main part 2F of the housing 2A. One advantage of this arrangement is to strengthen the physical and electrical connection between the pressure-sensing mechanism land the control unit 2. It also reduced flexing of the electrical circuit connection 1A at the junction 5 which might cause breaking of the electrical circuit connection 1A.

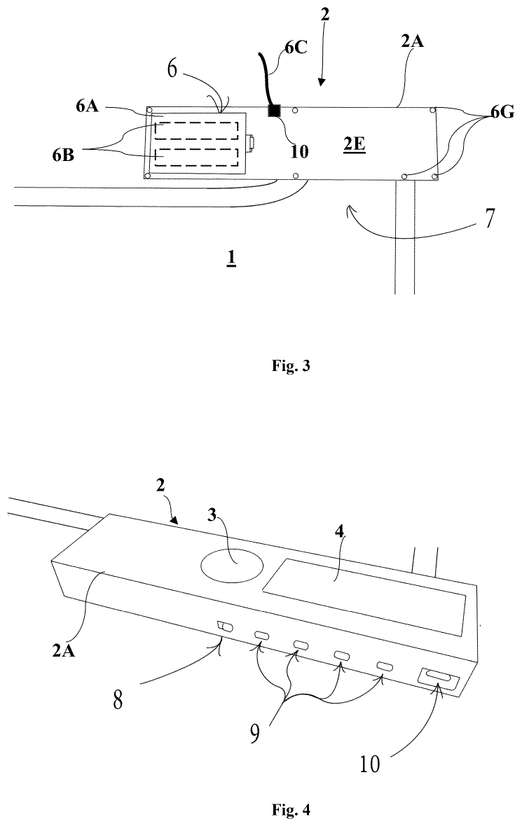

Referring to FIG. 3, which provides an enlarged plan view of the section of the system showing a rear or bottom view of the control unit 2, a battery compartment lid 6 is provided on the lid part 2E of the housing 2A. One or more batteries 6B, shown in dashed outline, can be accommodated in the battery compartment 6A to preferably comprise a secondary power source for the system. In one embodiment, the battery compartment 6A accommodates three 3 AAA batteries. Preferably, a USB cable 6C and a USB port 10 (FIG. 4) comprise a primary power source for the system.

The lid part 2E of the housing 2A may be fixed to the main part 2F by any suitable fixing means. In one embodiment, the fixing means may comprise a plurality of screws 6G denoted by small circles in FIG. 3.

Numeral “7” in FIG. 3 denotes a bottom surface of the pressure-sensing mechanism 1.

Referring to FIG. 4, shown is an enlarged perspective view of an embodiment of the control unit 2 showing various control buttons and other features of the control unit. Numeral “8” denotes a power switch, i.e., an ON/OFF switch. Numeral 9 denotes a series of control buttons which allow the user to use or implement the various functions of the system, such as, for example, setting an alarm time, setting current time, setting a 12/24-hour display, changing between different alarm sounds, setting volume levels, setting how long the system requires the user to step on the pressure-sensing mechanism 1 before the alarm signal shuts-off, setting a pattern of pattern of applied foot pressure to shut-off the alarm signal, and/or quickly setting alarm increments such as 5, 10 or 20 minute alarms increments. The latter is useful for users who wish to nap such as a daytime nap or to have a Pomodoro reminder to, for example go for a short walk, have a stretch, or other form of brief exercise. The USB port 10 for receiving the USB cable 6C is positioned near an end of the housing 2A of the control unit 2.

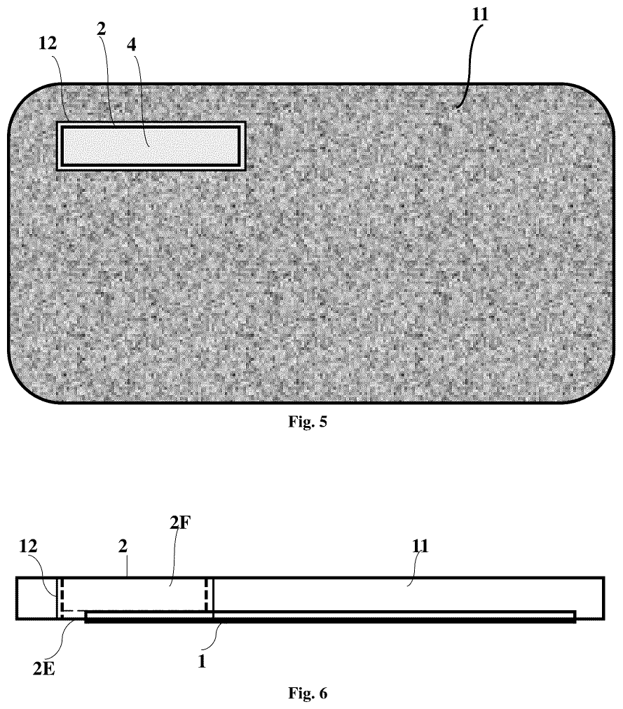

Referring to FIG. 5, shown is a plan view of the system including a cover 11 for covering over or enveloping at least the pressure-sensing mechanism 1. In the embodiment of FIG. 5 where the control unit 2 is physically connected to the pressure-sensing mechanism 1, the cover 11 includes a window or aperture 12 to enable a user to view the display 4 of the control unit 2. FIG. 6 provides a side view of the embodiment of FIG. 5.

In one embodiment, the cover 11 comprises a carpet or mat which overlays the pressure-sensing mechanism 1 with the control unit 2 extending upwardly into the aperture 12 of the carpet or mat. The carpet or mat may be formed of a memory foam material. The internal edge of the aperture 12 may be strengthened or reinforced to prevent wear. Preferably, the aperture 12 is sized to receive the control unit 2 and form a friction-fit therewith. Preferably, also, the housing 2A of the control unit 2 is formed to have a same color as the carpet or may, or a translucent cover film having a same color as the carpet or mat is provided to cover the housing 2A yet enable a user to see the display 3 through the, the translucent cover film.

In one embodiment, the pressure-sensing mechanism 1 is detachable is physically and electrically detachable from the control unit 2. This enables the pressure-sensing mechanism 1 and/or the control unit 2 to be replaced. One advantage of this arrangement is that it enables different sized and/or shaped pressure-sensing mechanisms 1 to be used with the control unit 2. This has the further advantage of enabling the system of the invention to be customized. The system may be customized with different shapes, sizes, and/or patterns of carpets or mats.

In one embodiment, the system alarm can be disabled in advance of the preset alarm time by pressing on the pressure-sensing mechanism 1 a predetermined number of time within a predetermined time period. For example, if a person wakes before their set alarm time, they may disable the alarm for that morning or day by getting out of bed and pressing on the pressure-sensing mechanism 1 eight times for example within 4 seconds for example. The display of the control unit 2 may signal to the user to confirm that the alarm is being disabled for only that morning or day by further pressing the pressure-sensing mechanism 1 by a different predetermined number of time within a further predetermined time period.

Referring to FIG. 7, which provides an exploded side view of another embodiment of the system of the invention, the system may comprise one or more non-slip layers or films to prevent sliding of at least the pressure-sensing mechanism 1 on a smooth floor or the like. A first non-slip layer 13 may be provided under the pressure-sensing mechanism 1. The first non-slip layer 13 may comprise a non-slip film applied to a bottom surface of the pressure-sensing mechanism 1. Additionally, or alternatively, a second non-slip layer 14 may be provided between the cover 11 and the pressure-sensing mechanism 1 . . . . The second non-slip layer 14 may comprise a non-slip film applied to a bottom surface of the cover and/or to a top surface of the pressure-sensing mechanism 1.

Preferably, the sheet form pressure-sensing mechanism 1 is foldable or rollable to reduce a packaging footprint thereof.

The cover 11 may be supplied separately as a product to the combination of the control unit 2 and the pressure-sensing mechanism 1. One advantage is that a user is able to select a cover to a color or design of their choosing or to replace or renew the cover when worn. Furthermore, the cover 11 provides wear protection to at least the pressure-sensing mechanism 1. The cover 11 may also keep at least the pressure-sensing mechanism 1 clean.

The system of the invention may be supplied as a kit of parts comprising the pressure-sensing mechanism 1, the control unit 2, and one or more covers 11.

One embodiment of the invention comprises a pressure-sensitive floor mat alarm clock system for facilitating a getting out of bed or wake up routine having a pressure-sensing mechanism 1 capable of detecting touch input. The system includes a control unit 2 configured to receive a touch input signal from the pressure-sensing mechanism 1 to shut-off an alarm signal. A display or display interface is provided for displaying any one or more of: a clock time; an alarm set time; or modes of the system. An input interface is provided for allowing a user to adjust any one or more of: a wake-up time; a time required for the pressure-sensing mechanism to detect touch before the alarm signal is shut-off; selection of one or more alarm signals; a volume setting for an audible alarm signal; and overall navigation of the system's functions. The system may include an audio speaker system 3 for outputting an audible alarm signal at one or more selectable volumes with a highest volume of over 100 decibels. It may also include at least two power sources comprising a primary power source provided by a USB cable And USB port, and a secondary power source comprising a battery compartment for receiving one or more batteries.

The control unit 2 is preferably programmable to implement any one or more of the following: setting how long in time pressure must be applied to the pressure-sensing mechanism before the alarm signal is shut-off, preferably ranging from 3 to 60 seconds; changing a sound of the alarm from a selection of pre-set alarm sounds; setting alarm clock functions such as current time, alarm time, alarm ON/OFF; changing alarm signal volume up to over 100 decibels; or shutting-off the alarm signal before it is initiated by touching the pressure-sensing mechanism a plurality of times in quick succession.

The display interface may be activated by touch to display the current time thereby allowing the system to function also as a night light.

The invention also provides a non-transitory computer-readable medium, e.g., a memory 2D storing machine-readable instructions, wherein, when the machine-readable instructions are executed by a processor 2C, they configure the processor 2C to implement the functions of the system of the invention.

The apparatus described above may be implemented at least in part in software. Those skilled in the art will appreciate that the apparatus described above may be implemented at least in part using general purpose computer equipment or using bespoke equipment.

Here, aspects of the methods and apparatuses described herein can be executed on any apparatus comprising the communication system. Program aspects of the technology can be thought of as “products” or “articles of manufacture” typically in the form of executable code and/or associated data that is carried on or embodied in a type of machine-readable medium. “Storage” type media include any or all of the memory of the mobile stations, computers, processors or the like, or associated modules thereof, such as various semiconductor memories, tape drives, disk drives, and the like, which may provide storage at any time for the software programming. All or portions of the software may at times be communicated through the Internet or various other telecommunications networks. Such communications, for example, may enable loading of the software from one computer or processor into another computer or processor. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible non-transitory “storage” media, terms such as computer or machine “readable medium” refer to any medium that participates in providing instructions to a processor for execution.

While the invention has been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

In the claims which follow and in the preceding description of the invention, except where the context requires otherwise due to express language or necessary implication, the word “comprise” or variations such as “comprises” or “comprising” is used in an inclusive sense, i.e., to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art.

1. A pressure-sensitive floor mat alarm clock system comprising:
a sheet form pressure-sensing mechanism for detecting pressure applied thereto by a human foot placed thereon; and
a control unit cooperative with the pressure-sensing mechanism to receive an input signal from the pressure-sensing mechanism when pressure is applied to the pressure-sensing mechanism by a human foot, the control unit configured to terminate output of an audible and/or a visual alarm signal in response to receipt of an input signal from the pressure-sensing mechanism;
wherein the control unit is configured to terminate output of the audible and/or the visual alarm signal upon a determination that the input signal from the pressure-sensing mechanism is indicative of a user applying foot pressure to the pressure-sensing mechanism for a preset or predetermined duration of time and/or by a predetermined pattern of applied foot pressure.

2. The system of claim 1, wherein the control unit is configured to discriminate between foot pressure applied to the pressure-sensing mechanism by the user and other means of pressure being applied by the user to the pressure-sensing mechanism.

3. The system of claim 2, wherein the control unit is configured to discriminate based on a predetermined or calculated pressure threshold whereby, if a detected touch pressure on the pressure-sensing mechanism is below the predetermined or calculated pressure then the control unit determines that the user has not applied foot pressure to the pressure-sensing mechanism.

4. The system of claim 3, wherein the predetermined or calculated pressure threshold is based on one or more inputted parameters to the control unit comprising the user's weight and/or the user's foot size.

5. The system of claim 1, further comprising a cover for covering over or enveloping at least the pressure-sensing mechanism.

6. The system of claim 5, wherein the cover is provided separately as a product to the combination of the control unit and the pressure-sensing mechanism.

7. The system of claim 5, wherein, where the control unit is physically connected to the pressure-sensing mechanism, the cover includes a window to enable a user to view a display of the control unit.

8. The system of claim 7, wherein the cover comprises a carpet, the window comprises an aperture in the carpet, and the aperture is sized to receive the control unit and form a friction-fit therewith.

9. The system of claim 5, wherein a housing of the control unit is formed with a same color as the carpet or a translucent cover is provided for the control unit, the translucent cover having a same color as the carpet.

10. The system of claim 1, further comprising a non-slip layer under the pressure-sensing mechanism.

11. The system of claim 10, wherein the non-slip layer comprises a non-slip film applied to a bottom surface of the pressure-sensing mechanism.

12. The system of claim 8, further comprising a non-slip layer between the carpet and the pressure-sensing mechanism.

13. The system of claim 1, wherein the sheet form pressure-sensing mechanism is foldable to reduce a packaging footprint thereof.

14. The system of claim 1, wherein the control unit is programmable by a user.

15. The system of claim 1, wherein, where the control unit is physically connected to the pressure-sensing mechanism, a part of the sheet form pressure-sensing mechanism extends into a volume defined by a housing of the control unit and is physically trapped or clamped between a main housing part and a cover of the housing.

16. A pressure-sensitive floor mat alarm clock system for facilitating a getting out of bed or wake up routine, the system comprising:
a pressure-sensing mechanism capable of detecting touch input;
a control unit configured to receive a touch input signal from the pressure-sensing mechanism and to shut-off an alarm signal;
a display interface for displaying a clock time; and
an input interface for allowing a user to adjust any of: a wake-up time; a time required for the pressure-sensing mechanism to detect touch before the alarm signal is shut-off; selection of one or more alarm signals; a volume setting for an audible alarm signal; and overall navigation of the system's functions.

17. The system of claim 16, further comprising an audio speaker system for outputting an audible alarm signal at one or more selectable volumes with a highest volume of over 100 decibels; and at least two power sources comprising a primary power source provided by a USB cable and a secondary power source comprising a battery compartment for receiving one or more batteries.

18. The system of claim 16, wherein the control unit is programmable to implement any of the following:
set how long pressure must be applied to the pressure-sensing mechanism before the alarm signal is shut-off, ranging from 3 to 60 seconds;
changing a sound of the alarm from a selection of pre-set alarm sounds;
setting alarm clock functions such as current time, alarm time, alarm ON/OFF;
changing alarm signal volume up to over 100 decibels;
shutting-off the alarm signal before it is initiated by touching the pressure-sensing mechanism a plurality of times in quick succession.

19. The system of claim 16, wherein the display interface is activated by touch to display the current time thereby allowing the system to function also as a night light.

20. A kit of parts comprising a pressure-sensing floor mat alarm clock system, the kit of parts comprising:
a sheet form pressure-sensing mechanism for detecting pressure applied thereto by a human foot placed thereon;
a control unit cooperative with the pressure-sensing mechanism to receive an input signal from the pressure-sensing mechanism when pressure is applied to the pressure-sensing mechanism by a human foot, the control unit configured to output an audible and/or a visual alarm signal in response to receipt of an input signal from the pressure-sensing mechanism; wherein the control unit is configured to output the audible and/or the visual alarm signal upon a determination that the input signal from the pressure-sensing mechanism is indicative of a user applying foot pressure to the pressure-sensing mechanism for a predetermined duration of time and/or by a predetermined pattern of applied foot pressure; and
a cover for covering over or enveloping at least the pressure-sensing mechanism.
